(19) United States
(12) Patent Application Publication
(10) Pub. No.: US 2009/0274837 A1
(43) Pub. Date: Nov. 5, 2009

(54) METHOD OF PRODUCING THE MAGNETORESISTIVE DEVICE OF THE CPP TYPE

(75) Inventors: Shinji Hara, Tokyo (JP); Yoshihiro Tsuchiya, Tokyo (JP); Tomohito Mizuno, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TDK CORPORATION, Tokyo (JP)

(21) Appl. No.: 12/112,598

(22) Filed: Apr. 30, 2008

(51) Int. Cl. B05D 5/12

(52) U.S. Cl. 427/128

(57) ABSTRACT

The invention provides a process for the formation of a sensor site of a magnetoresistive device in which the first ferromagnetic layer and a nonmagnetic intermediate layer are formed in order, then surface treatment is applied to the surface of the nonmagnetic intermediate layer, and thereafter the second ferromagnetic layer is formed on the thus treated surface of the nonmagnetic intermediate layer. The surface treatment is implemented by a method of letting a modification element hit right on the surface of the nonmagnetic intermediate layer using a vacuum. The nonmagnetic intermediate layer is composed mainly of an oxide or nitride, and the modification element is a low-melting element having a melting point of 500° C. or lower. It is thus possible to reduce spin scattering while reducing oxidization or nitriding of the surfaces of the ferromagnetic layers used for the sensor site, thereby achieving high MR change rates. There is also a limited dispersion of the MR change rate with extremely improved reliability.

### BACKGROUND OF THE INVENTION

1. Field of the Invention

The present invention relates to a fabrication process for magnetoresistive devices adapted to read the magnetic field intensity of magnetic recording media or the like as signals.

2. Explanation of the Prior Art

In recent years, with an increase in the recording density of magnetic disk systems, there have been growing demands for improvements in the performance of thin-film magnetic heads. For the thin-film magnetic head, a composite type thin-film magnetic head has been widely used, which has a structure wherein a reproducing head having a read-only magnetoresistive device (hereinafter often called the MR (magnetoresistive) device for short) and a recording head having a write-only induction type magnetic device are stacked together on a substrate.

With an increase in the recording density, there has also been a mounting demand for the reproducing head to have a shield gap structure with a narrower spacing between two shields or a narrower track structure with a narrower spacing between tracks. As the reproducing head track grows narrow with a decreasing device height, so does the device area; however, with the prior art structure, there is an operating current limited from the standpoint of reliability, because there is heat dissipation efficiency decreasing with a decreasing area.

To solve such a problem, there is a head structure proposed in the art, in which a first shield film and a second shield film with a magnetoresistive film sandwiched between them are connected electrically in series to make do without any insulating layer between the shields (for instance, JP(A)9-288807). Called the current perpendicular to plane (CPP) structure, such a head structure is thought of as inevitable to achieve recording densities exceeding 700 Gbits/in². Tunneling magneto-resistive (TMR) or CPP-GMR devices now under research and development have that structure.

The MR devices require high magnetoresistive change rates (MR change rates). In other words, the MR change rate leads to output: the MR devices must essentially have high magnetoresistive change rates from the standpoint of S/N ratio.

A sensor site of the MR device is built up of a multilayer device unit in which a first ferromagnetic layer, a nonmagnetic intermediate layer (e.g., a metal oxide or nitride) and a second ferromagnetic layer are stacked together in order. One approach desired for obtaining high magnetoresistive change rates in the formation of such a multilayer device unit structure is to keep the surfaces of the ferromagnetic layers clean, for instance, free of adsorbed oxygen.

Indeed, however, the ferromagnetic layers are in contact with the nonmagnetic intermediate layer formed of, e.g., a metal oxide: it would be very difficult to keep those surfaces clean and free of, for instance, adsorbed oxygen insofar as the state of the art is concerned. The provision of an antioxidant layer on the interface is not preferred because of causing spin scattering that in turn results in a lowering of the MR change rate.

The situations being like such, an object of the invention is to provide a novel magnetoresistive device fabrication process that provides a solution to the aforesaid problem, thereby achieving high MR change rates while preventing oxidation or nitiridng of the surfaces of the ferromagnetic layers forming the sensor site and, at the same time, getting around spin scattering.

### SUMMARY OF THE INVENTION

According to the invention of this application, the aforesaid object is accomplishable by the provision of a fabrication process for a magnetoresistive device of the CPP (current perpendicular to plane) structure, which comprises a nonmagnetic intermediate layer, and a first ferromagnetic layer and a second ferromagnetic layer stacked and formed with said nonmagnetic intermediate layer sandwiched between them, and in which an angle made between the directions of magnetization of both said ferromagnetic layers is capable of functioning in such a way as to change relatively depending on an external magnetic field, with a sense current applied in a stacking direction, wherein:

said first ferromagnetic layer and said nonmagnetic intermediate layer are formed in order, then surface treatment is applied to the surface of said nonmagnetic intermediate layer, and thereafter said second ferromagnetic layer is formed on the thus treated surface of said nonmagnetic intermediate layer, said surface treatment is implemented by a method of letting a modification element hit right on the surface of said nonmagnetic intermediate layer using a vacuum, said nonmagnetic intermediate layer is composed mainly of an oxide or nitride, and said modification element is a low-melting element having a melting point of 500° C. or lower.

In a preferable embodiment of the inventive fabrication process, said surface treatment is operated such that the surface of said nonmagnetic intermediate layer is just enough modified by the low-melting element having a melting point of 500° C. or lower.

In a preferable embodiment of the inventive fabrication process, the operation for just enough modification by the low-melting element having a melting point of 500° C. or lower is implemented in a range where there is an improvement in the MR change rates.

In a preferable embodiment of the inventive fabrication process, the operation for just enough modification by the low-melting element having a melting point of 500° C. or lower is implemented in a range where diffusion of oxygen through said second ferromagnetic layer is prevented and there is no damage to spin conduction.

In a preferable embodiment of the inventive fabrication process, said method of letting a modification element hit right on the surface of the nonmagnetic intermediate layer using a vacuum is a vapor deposition, ion plating or vapor-phase growth technique.

In a preferable embodiment of the inventive fabrication process, said nonmagnetic intermediate layer is composed mainly of at least one oxide selected from the group consisting of MgO, Al₂O₃, ZnO, TiO₂, In₂O₃, SnO₂ and ZrO₂.

In a preferable embodiment of the inventive fabrication process, said nonmagnetic intermediate layer is composed mainly of at least one nitride selected from the group consisting of AlN, TiN, TaN, CuN, ZnN, ZrN and GaN.

In a preferable embodiment of the inventive fabrication process, said nonmagnetic intermediate layer is a Cu/MgO or Cu/ZnO multilayer.

In a preferable embodiment of the inventive fabrication process, said low-melting element having a melting point of 500° C. or lower is Zn, Pb, Cd, Ti, Bi, Sn, Se, Li, In, I, S, Na, K, P, Rb, Ga, or Cs.

In a preferable embodiment of the inventive fabrication process, said low-melting element having a melting point of 500° C. or lower is Zn, Sn, or In.

In a preferable embodiment of the inventive fabrication process, said nonmagnetic intermediate layer is composed mainly of at least one oxide selected from the group consisting of MgO, Al₂O₃, and ZnO.

The invention also provides a process for the fabrication of a thin-film magnetic head, comprising a plane in opposition to a recording medium, a magneto-resistive device located near said medium opposite plane to detect a signal magnetic field from said recording medium, and a pair of electrodes from passing a current in the stacking direction of said magnetoresistive device, wherein said magnetoresistive device is fabricated by the aforesaid fabrication process.

Further, the invention provides a process for the fabrication of a head gimbal assembly, comprising a slider including a thin-film magnetic head and located in such a way as to oppose to a recording medium, and a suspension adapted to resiliently support said slider, wherein said thin-film magnetic head is fabricated by the aforesaid fabrication process.

Yet further, the invention provides a process for the fabrication of a magnetic disk system, comprising a slider including a thin-film magnetic head and located in such a way as to oppose to a recording medium, and a positioning device adapted to support and position said slider with respect to said recording medium, wherein said thin-film magnetic head is fabricated by the aforesaid fabrication process.

### BRIEF EXPLANATION OF THE DRAWINGS

FIG. 1 is primarily illustrative in section of the reproducing device in the reproducing head in one embodiment of the invention, as taken parallel with a medium opposite plane.

FIG. 2 is a sectional view as taken on an arrowed A-A section in FIG. 1.

FIG. 3 is illustrative in section of the thin-film magnetic head perpendicular to the so-called air bearing surface (ABS).

FIG. 4 is illustrative in perspective of the slider included in the head gimbal assembly according to one embodiment of the invention.

FIG. 5 is illustrative in perspective of the head arm assembly comprising the head gimbal assembly according to one embodiment of the invention.

FIG. 6 is illustrative of part of the hard disk system according to one embodiment of the invention.

FIG. 7 is a plan view of the hard disk system according to one embodiment of the invention.

FIG. 8 is a graph indicative of the relations of the surface treating time (modification time) vs. the normalized MR ratio.

FIG. 9 is a graph indicative of the relations of the surface treating element (Zn, Sn, In, Al, Mg) used vs. the standard deviation (σ) of magnetoresistive change rates.

FIG. 10 is a graph indicative of the relations of the surface treating time (modification time) vs. the normalized MR ratio.

FIG. 11 is a graph indicative of the relations of the surface treating element (Zn, Sn, In, Al, Mg) used vs. the standard deviation (σ) of magnetoresistive change rates.

FIG. 12 is a graph indicative of the relations of the surface treating time (modification time) vs. the normalized MR ratio.

FIG. 13 is a graph indicative of the relations of the surface treating element (Zn, Sn, In, Al, Mg) used vs. the standard deviation (σ) of magnetoresistive change rates.

### EXPLANATION OF THE PREFERRED EMBODIMENTS

The best mode for carrying out the invention is now explained in details.

Prior to giving an account of how to fabricate the magnetoresistive device according to the invention, reference is made to a typical arrangement of the magneto-resistive device to be fabricated by the invention, and the construction of a thin-film magnetic head comprising that magnetoresistive device, etc.

It is here noted that the magnetoresistive device to be fabricated is never limited to such device type and structure as detained below, insofar as the states of two magnetic layers functioning as a sensor change relatively depending on an external magnetic field.

Of course, the invention of this application may just as well be applied to a magnetoresistive device having a simple three-layered structure of ferromagnetic layer/nonmagnetic intermediate layer/ferromagnetic layer as a basic structure, as set forth in, for instance, U.S. Pat. Nos. 7,019,371B2 and 7,035,062B1.

### [Explanation of a Typical Arrangement of the Magneto-Resistive Device]

A giant magnetoresistive device of the CPP structure (the CPP-GMR device) is now explained as a typical example of the magnetoresistive device; however, the invention of this application is not limited to such device structure as mentioned above.

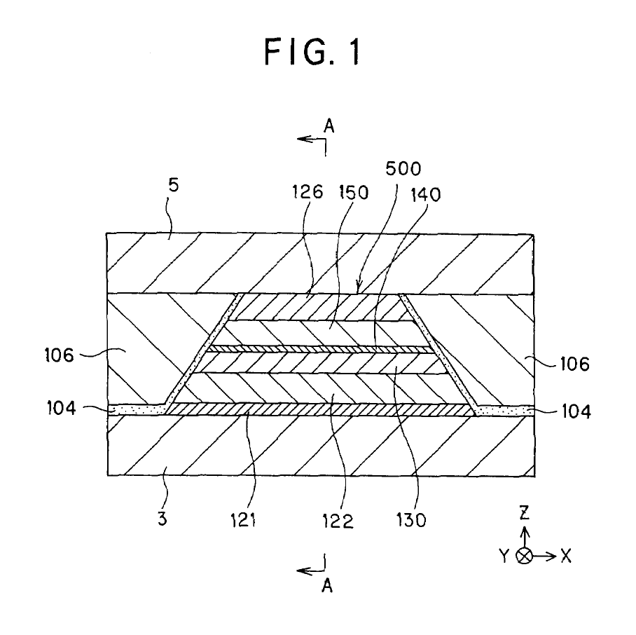

FIG. 1 is illustrative of the ABS (air bearing surface) of a reproducing head in an embodiment of the invention; FIG. 1 is illustrative in schematic of the ABS of the giant magnetoresistive device (CPP-GMR device) having the CPP structure in particular. The ABS is generally corresponding to a plane (hereinafter often called the medium opposite plane) at which a reproducing head is in opposition to a recording medium; however, it is understood that the ABS here includes even a section at a position where the multilayer structure of the device can be clearly observed. For instance, a protective layer of DLC or the like (the protective layer adapted to cover the device), in a strict sense, positioned facing the medium opposite plane may be factored out, if necessary.

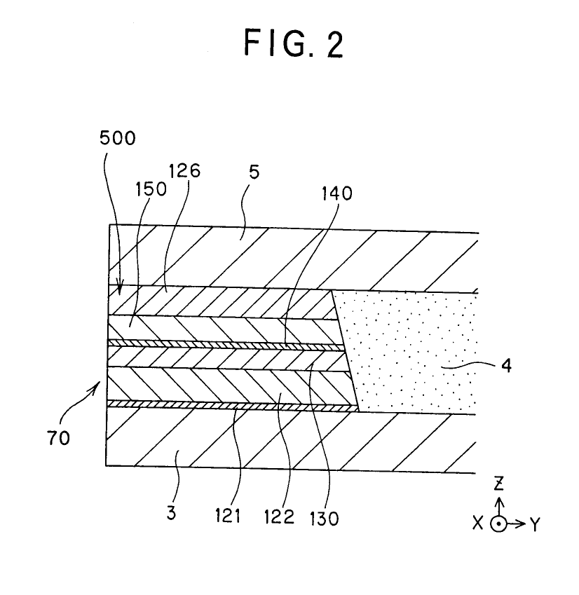

FIG. 2 is a view as taken on the arrowed A-A section of FIG. 1.

In the following disclosure of the invention, the sizes of each device component in the X-, Y- and Z-axis directions shown in the drawings will be referred to as the “width”, “length” and “thickness”, respectively. The side of the device nearer to the air bearing surface (the plane of the thin-film magnetic head in opposition to the recording medium) in the Y-axis direction will be called “forward” and the opposite side (depth-wise side) will be called “rearward”, and the direction of stacking the individual films up will be called “upward” or “upper side” and the opposite direction will be called “downward” or “lower side”.

As shown in FIG. 1, the reproducing head according to the embodiment here comprises a first shield layer 3 (also called the lower shield layer 3) and a second shield layer 5 (also called the upper shield layer 5) that are located at a given space and opposed vertically on the sheet, a giant magnetoresistive device 500 (hereinafter referred to as the GMR device 500) interposed between the first shield layer 3 and the second shield layer 5, and an insulating film 104 formed directly on two sides of the GMR device 500 (see FIG. 1). Note here that in the rear (see FIG. 2) of the GMR device 500, there is a refill layer 4 formed that is an insulating layer.

Further, as shown in FIG. 1, two bias magnetic field-applying layers 106 are formed on two sides of the GMR device 500 via the insulating layer 104.

In the embodiment here, the first 3 and the second shield layer 5 take a so-called magnetic shield role plus a pair-of-electrodes role. In other words, they have not only a function of shielding magnetism but also function as a pair of electrodes adapted to pass a sense current through the GMR device 500 in a direction intersecting the plane of each of the layers forming the GMR device 500, for instance, in a direction perpendicular to the plane of each of the layers forming the GMR device 500 (stacking direction).

Apart from the first 3 and the second shield layer 5, another pair of electrodes may be additionally provided above and below the device.

Referring to the GMR device 500 having the CPP structure here in terms of a broad, easy-to-understand concept, it comprises a nonmagnetic intermediate layer 140, and a first ferromagnetic layer 130 and a second ferromagnetic layer 150 stacked together with the nonmagnetic spacer intermediate layer 140 sandwiched between them, as shown in FIG. 1. The first ferromagnetic layer 130 and the second ferromagnetic layer 150 function such that the angle made between the directions of magnetizations of both layers changes relatively depending on an external magnetic field.

Referring here to a typical embodiment of the invention, the first ferromagnetic layer 130 functions as a fixed magnetization layer (pinned layer) having its magnetization fixed, and the second ferromagnetic layer 150 functions as a free layer having a direction of its magnetization changing depending on an external magnetic field, i.e., a signal magnetic field from a recording medium. It follows that the first ferromagnetic layer 130 is the fixed magnetization layer 130, and the second ferromagnetic layer 150 is the free layer 150.

The fixed magnetization layer 130 has its magnetization direction fixed under the action of an antiferromagnetic layer 122. While an embodiment with the antiferromagnetic layer 122 formed on a substrate side (the side of the first shield layer 3) is shown in FIG. 1, it is contemplated that the antiferromagnetic layer 122 may be formed on a top side (the side of the second shield layer 5) to interchange the free layer 150 and the fixed magnetization layer 130 in position.

In what follows, the layers forming the GMR device 500 are each now explained in greater details.

### (Explanation of the Fixed Magnetization Layer 130)

In the invention, the fixed magnetization layer 130 (the first ferromagnetic layer 130) is formed on the antiferromagnetic layer 122 having a pinning action via the underlay layer 121 formed on the first shield layer 3.

The fixed magnetization layer 130 may be configured in either one single film form or multilayer film form.

Referring typically to the multilayer film form that is a preferable form, the fixed magnetization layer 130 has a so-called synthetic pinned layer comprising, in order from the side of the antiferromagnetic layer 122, an outer layer, a nonmagnetic layer and an inner layer, all stacked together in order.

The outer and the inner layer are each provided by a ferromagnetic layer made of, for instance, a ferromagnetic material containing Co, and Fe. The outer and the inner layer are antiferromagnetically coupled and fixed such that their magnetization directions are opposite to each other.

The outer, and the inner layer is preferably formed of, for instance, a Co₇₀Fe₃₀ (at %) alloy layer. The outer layer has a thickness of preferably about 3 to 7 nm, and the inner layer has a thickness of preferably about 3 to 10 nm.

The nonmagnetic layer, for instance, is made of a nonmagnetic material containing at least one selected from the group consisting of Ru, Rh, Ir, Re, Cr, Zr and Cu, and has a thickness of, for instance, about 0.35 to 1.0 nm. The nonmagnetic layer is provided to fix the magnetizations of the inner and the outer layers in opposite directions.

### (Explanation of the Free Layer 150 and Cap Layer 126)

The free layer 150 has its magnetization direction changing depending on an external magnetic field, i.e., a signal magnetic field from the recording medium, and is formed of a ferromagnetic layer (soft magnetic layer) having a small coercive force. The free layer 150 has a thickness of, for instance, about 2 to 10 nm, and may be in either a single layer form or a multilayer form including a plurality of ferromagnetic layers.

As shown in FIG. 1, there is the cap (protective) layer 126 formed on such free layer 150. The cap layer 126, for instance, is formed of a Ta or Ru layer, and has a thickness of about 0.5 to 20 nm.

### (Explanation of the Nonmagnetic Intermediate Layer 140)

As can be seen from the explanation of the fabrication process given later, the nonmagnetic intermediate layer 140 is formed of an oxide or nitride. That is, the nonmagnetic intermediate layer 140 is composed mainly of at least one oxide selected from the group consisting of MgO, Al₂O₃, ZnO, TiO₂, In₂O₃, SnO₂ and ZrO₂, or at least one nitride selected from the group consisting of AlN, TiN, TaN, CuN, ZnN and GaN. Accordingly, the nonmagnetic intermediate layer may be in either a single layer form of them or a multilayer form such as Cu/MgO and Cu/ZnO, and have a thickness of, for instance, about 1.0 to 3.0 nm.

### (Explanation of the Antiferromagnetic Layer 122)

The antiferromagnetic layer 122 functioning as the pinning layer works such that by way of exchange coupling with the fixed magnetization layer 130 as described above, the magnetization direction of the fixed magnetization layer 130 is fixed.

For instance, the antiferromagnetic layer 122 is made of an antiferromagnetic material containing at least one element M′ selected from the group of Pt, Ru, Rh, Pd, Ni, Cu, Ir, Cr and Fe, and Mn. The content of Mn is preferably 35 to 95 at %. The antiferromagnetic material is broken down into two types: (1) a non-heat treatment type antiferromagnetic material that shows anti-ferromagnetism even in the absence of heat treatment to induce an exchange coupling magnetic field between it and a ferromagnetic material, and (2) a heat treatment type antiferromagnetic material that is going to show anti-ferromagnetism by heat treatment. In the invention, both types (1) and (2) may be used without restriction. For instance, the non-heat treatment type antiferromagnetic material is exemplified by RuRhMn, FeMn, and IrMn, and the heat treatment type antiferromagnetic material is exemplified by PtMn, NiMn, and PtRhMn.

The antiferromagnetic layer 122 has a thickness of about 4 to 30 nm.

It is here noted that for the layer for fixing the magnetization direction of the fixed magnetization layer 130, it is acceptable to use a hard magnetic layer comprising a hard magnetic material such as CoPt in place of the aforesaid antiferromagnetic layer.

The underlay layer 121 formed below the anti-ferromagnetic layer 122 is provided to improve on the crystallizability and orientation of each of the layers stacked on it in general, and the exchange coupling of the antiferromagnetic layer 122 and the fixed magnetization layer 130 in particular. For such underlay layer 121, for instance, a NiCr layer or a multilayer of Ta and NiCr layers is used. The underlay layer 121 has a thickness of about 2 to 6 nm as an example.

Further, the insulating layer 104 shown in FIG. 1 is made of, for instance, alumina. For the bias magnetic field-applying layers 106, for instance, a hard magnetic layer (hard magnet) or a multilayer structure of a ferromagnetic layer and an antiferromagnetic layer may be used, and there is the specific mention of CoPt or CoCrPt.

### [Explanation of the Whole Structure of the Thin-Film Magnetic Head]

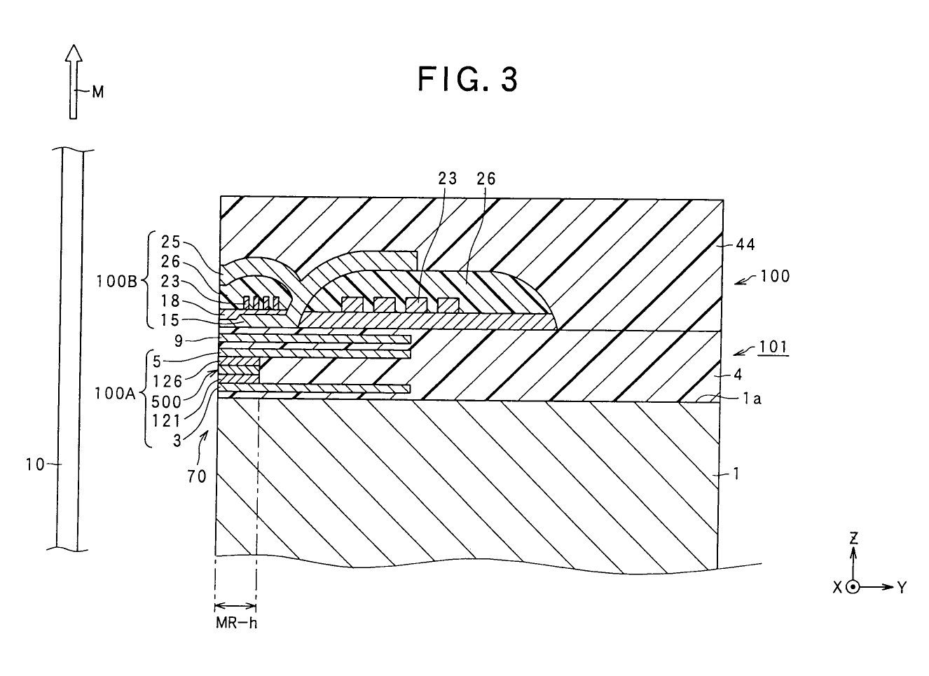

FIG. 3 is illustrative in section (section in the Y-Z plane) of a thin-film magnetic head parallel with the so-called air bearing surface (ABS).

A thin-film magnetic head 100 shown in FIG. 3 is used on a magnetic recording system such as a hard disk drive for the purpose of applying magnetic processing to a recording medium 10 like a hard disk moving in a medium travel direction M.

The thin-film magnetic head 100 illustrated in the drawing is a composite type head capable of implementing both recording and reproducing as magnetic processing. The structure comprises, as shown in FIG. 3, a slider substrate 1 made of a ceramic material such as AlTiC (Al₂O₃.TiC), and a magnetic head unit 101 formed on the slider substrate 1.

The magnetic head unit 101 has a multilayer structure comprising a reproducing head portion 100A adapted to implement reproducing process for magnetic information recorded by making use of the magneto-resistive (MR) effect and a shield type recording head portion 100B adapted to implement, for instance, a perpendicular recording type recording processing.

A detailed account is now given below.

A first shield layer 3 and a second shield layer 5 are each a planar layer formed in such a way as to be almost parallel with the side la of the slider substrate 1, forming a part of the ABS that is a medium opposite plane 70.

A magnetoresistive device 500 is disposed in such a way as to be held between the first 3 and the second shield layer 5, forming a part of the medium opposite plane 70. And a height in the perpendicular direction (Y-direction) to the medium opposite plane 70 defines an MR height (MR-h).

For instance, the first 3 and the second shield layer 5 are each formed by pattern plating inclusive of frame plating or the like. Although not clearly illustrated in the drawing, it is understood that the first 3 and the second shield layer 5 must be set up in such a way as to produce the aforesaid advantages of the invention.

The magnetoresistive device 500 is a multilayer film formed in such a way as to be almost parallel with the side la of the slider substrate 1, forming a part of the medium opposite plane 70.

The magnetoresistive device 500 is a multilayer film of the current-perpendicular-to-plane type (CPP type) with a sense current passing in the direction perpendicular to the staking plane, and for such a multilayer film use is preferably made of a TMR (tunnel magnetoresistive) film or a CPP type GMR (giant magnetoresistive) film. Use of such a magnetoresistive device as the magnetoresistive device 500 enables a signal magnetic field from a magnetic disk to be sensed with very high sensitivity.

When the TMR device is used as the magnetoresistive device 500, it comprises a structure wherein an anti-ferromagnetic layer, a fixed magnetization layer, a tunnel barrier layer and a free magnetization layer (free layer) are stacked up in order. For the antiferromagnetic layer, use is made of a film made of IrMn, PtMn, NiMn, RuRhMn or the like and having a thickness of about 4 to 30 nm. The fixed magnetization layer is exemplified by a so-called synthetic pinned layer construction wherein, for instance, CoFe that is a ferromagnetic material or a nonmagnetic metal layer such as a Ru one is sandwiched between two layers of CoFe or the like. For the tunnel barrier layer, use is made of a film obtained by oxidizing a metal film made of Al, AlCu, Mg or the like and having a thickness of about 0.5 to 2 nm. The free magnetization layer (free layer) is made up of a two-layer film composed of CoFe or the like that is a ferromagnetic material and has a thickness of about 1 nm and NiFe or the like having a thickness of about 3 to 4 nm. The free magnetization layer (free layer) makes a tunnel junction to the fixed magnetization layer by way of the tunnel barrier layer. When the so-called CPP type GMR film is used as the magneto-resistive device 500, the tunnel barrier layer in the aforesaid TMR film may be replaced by a nonmagnetic, electroconductive film made of Cu or the like and having a thickness of about 1 to 3 nm.

As shown in FIG. 3, between the second shield layer 5 and the recording head portion 100B there is an inter-device shield layer 9 formed that is made of a similar material to that of the second shield layer 5.

The inter-device shield layer 9 keeps the magneto-resistive device 500 functioning as a sensor out of a magnetic field occurring from the recording head 100B, taking a role in prevention of extraneous noises upon reading. Between the inter-device shield layer 9 and the recording head portion 100B there may also be a backing coil portion formed. The backing coil portion is to generate a magnetic flux that cancels out a magnetic flux loop that is generated from the recording head portion 100B, passing through the upper and lower electrode layers of the magnetoresistive device 500: this backing coil portion works to hold back the wide adjacent track erasure (WATE) phenomenon that is unwanted writing or erasure operation with the magnetic disk.

At a gap between the first and second shield layers 3 and 5 on the side of the magnetoresistive device 500 that faces away from the medium opposite plane 70, at the rear of the first and second shield layers 3, 5 and the inter-device shield layer 9 that face away from the medium opposite plane 70, at a gap between the first shield layer 3 and the slider substrate 1, and at a gap between the inter-device shield layer 9 and the recording head portion 100B, there are insulating layers 4 and 44 formed, one each made of alumina or the like.

The recording head portion 100B is preferably constructed for the purpose of perpendicular magnetic recording, and comprises a main magnetic pole layer 15, a gap layer 18, a coil insulating layer 26, a coil layer 23 and an auxiliary magnetic pole layer 25, as shown in FIG. 3.

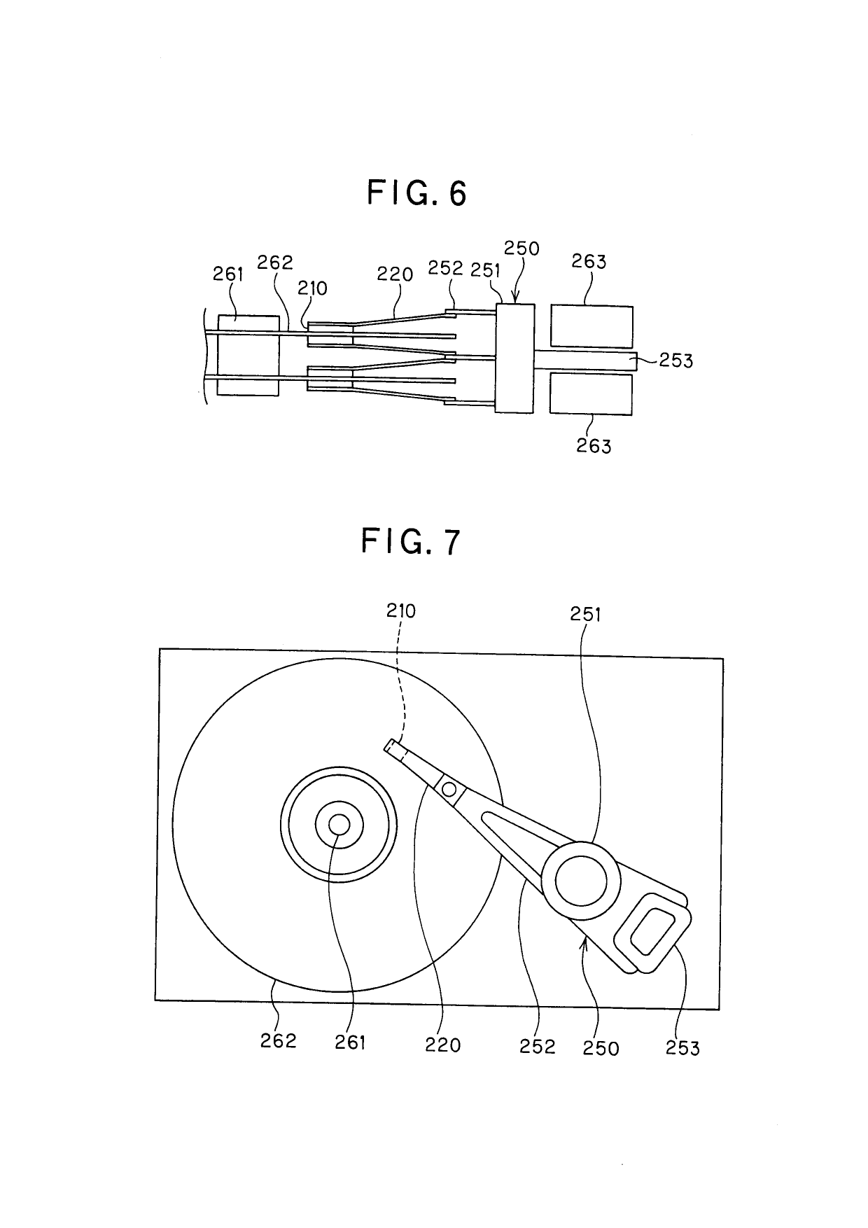

The main magnetic pole layer 15 is set up as a magnetic guide path for guiding a magnetic flux induced by the coil layer 23 to the recording layer of the magnetic recording medium 10 with information being to be written on it while converging that magnetic flux. At the end of the main magnetic pole layer 15 here that is on the medium opposite plane 70 side, the width in the track width direction (along the X-axis of FIG. 6) and thickness in the stacking direction (along the Z-axis of FIG. 3) of the main magnetic pole layer should preferably be less than those of the rest. Consequently, it is possible to generate a fine yet strong writing magnetic flux well fit for high recording densities.

The end on the medium opposite plane 70 side of the auxiliary magnetic pole layer 25 magnetically coupled to the main magnetic pole layer 15 forms a trailing shield portion having a layer section wider than that of the rest of the auxiliary magnetic pole layer 25. As shown in FIG. 3, the auxiliary magnetic pole layer 25 is opposed to the end of the main magnetic pole layer 15 on the medium opposite plane 70 side while the gap layer 18 made of an insulating material such as alumina and the coil insulating layer 26 are interposed between them.

By the provision of such auxiliary magnetic pole layer 25, it is possible to make steeper a magnetic field gradient between the auxiliary magnetic pole layer 25 and the main magnetic pole layer 15 near the medium opposite plane 70. Consequently, jitters of signal outputs diminish, resulting in the ability to minimize error rates upon reading.

The auxiliary magnetic pole layer 25, for instance, is formed at a thickness of, e.g., about 0.5 to 5 μm using frame plating, sputtering or the like. The material used may be an alloy comprising two or three of, for instance, Ni, Fe and Co, or comprising them as a main component with the addition of given elements to it.

The gap layer 18 is formed in such a way as to space the coil layer 23 away from the main magnetic pole layer 15. The gap layer 18 is constructed from Al₂O₃, DLC (diamond-like carbon) or the like having a thickness of, for instance, about 0.01 to 0.5 μm, and formed using, for instance, sputtering, CVD or the like.

### [Explanation of the Head Gimbal Assembly and the Hard Disk System]

Each one example of the head gimbal assembly and the hard disk system, used with the foregoing thin-film head mounted on it, is now explained.

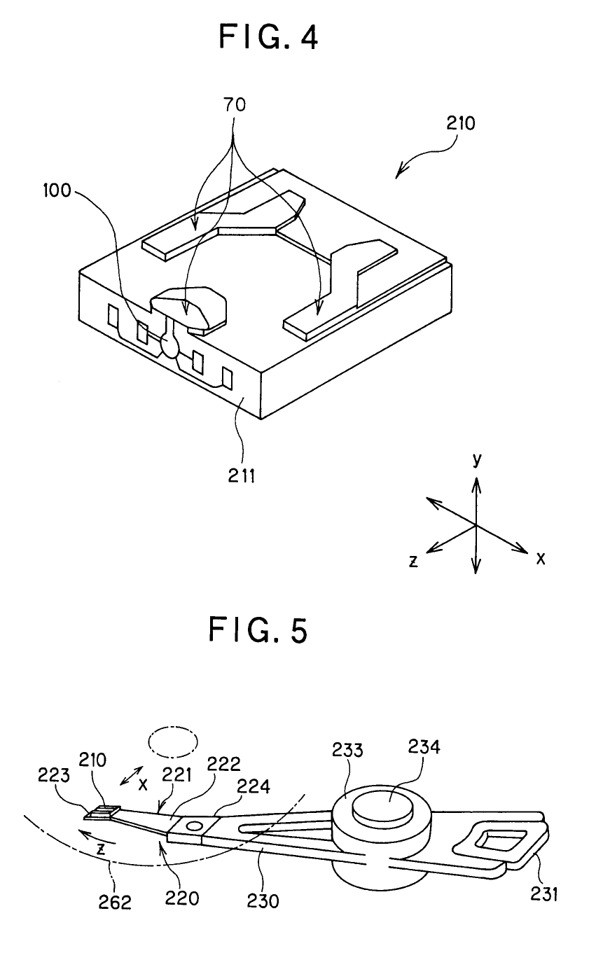

A slider 210 included in the head gimbal assembly is first explained with reference to FIG. 4. In the hard disk system, the slider 210 is located in such a way as to face a hard disk that is a rotationally driven disk-form recording medium. This slider 210 primarily comprises a substrate 211 built up of a substrate and an overcoat.

The substrate 211 is in a generally hexahedral shape. Of the six surfaces of the substrate 211, one surface is in opposition to the hard disk. On that one surface there is the medium opposite plane 70 formed.

As the hard disk rotates in the z-direction in FIG. 4, it causes an air flow passing between the hard disk and the slider 210 to induce lift relative to the slider 210 in the downward y-direction in FIG. 4. This lift in turn causes the slider 210 to levitate over the surface of the hard disk. Note here that the x direction in FIG. 4 traverses tracks on the hard disk.

Near the end of the slider 210 on an air exit side (the left lower end in FIG. 4), there is a thin-film magnetic head formed according to the embodiment here.

A head gimbal assembly 220 according to this embodiment is now explained with reference to FIG. 5. The head gimbal assembly 220 comprises a slider 210 and a suspension 221 adapted to resiliently support that slider 210. The suspension 221 comprises a leaf spring-form load beam 222 made of typically stainless steel, a flexure 223 attached to one end of the load beam 222 and having the slider 210 joined to it for giving a suitable degree of flexibility to the slider 210, and a base plate 224 attached to the other end of the load beam 222.

The base plate 224 is adapted to be attached to an arm 230 of an actuator for moving the slider 210 in the track traverse direction x of the hard disk 262. The actuator comprises the arm 230 and a voice coil motor for driving that arm 230. At a portion of the flexure 223 having the slider 210 attached to it, there is a gimbal portion provided for keeping the posture of the slider 210 constant.

The head gimbal assembly 220 is attached to the arm 230 of the actuator. The head gimbal assembly 220 attached to one arm 230 is called a head arm assembly, whereas the head gimbal assembly 220 attached to a carriage at its plurality of arms is referred to as a head stack assembly.

FIG. 5 illustrates one example of the head arm assembly, wherein the head gimbal assembly 220 is attached to one end of the arm 230. To the other end of the arm 230, a coil 231 forming a part of the voice coil motor is attached. Halfway across the arm 230, there is a bearing portion 233 attached to a shaft 234 adapted to support the arm 230 in a pivotal fashion.

Each one example of the head stack assembly and the hard disk system according to the embodiment here are now explained with reference to FIGS. 6 and 7.

FIG. 6 is illustrative of part of the hard disk system, and FIG. 7 is a plan view of the hard disk system.

A head stack assembly 250 comprises a carriage 251 having a plurality of arms 252. The plurality of arms 252 are provided with a plurality of the head gimbal assemblies 220 such that they line up perpendicularly at an interval. On the side of the carriage 251 that faces away from the arms 252, there is a coil 253 attached, which coil becomes a part of the voice coil motor. The head stack assembly 250 is incorporated in the hard disk system.

The hard disk system comprises a plurality of hard disks 262 attached to a spindle motor 261. For each hard disk 262, two sliders 210 are located such that they are opposite to each other with the hard disk 262 held between them. The voice coil motor has also permanent magnets 263 located at opposite positions with the coil 253 of the head stack assembly 250 held between them.

The head stack assembly 250 except the slider 210 and the actuator correspond to the positioning device here which is operable to support the slider 210 and position it relative to the hard disk 262.

With the hard disk system here, the actuator is actuated to move the slider 210 in the track traverse direction of the hard disk 262, thereby positioning the slider 210 with respect to the hard disk 262. The thin-film magnetic head incorporated in the slider 210 works such that information is recorded by a recording head in the hard disk 262, and the information recorded in the hard disk 262 is played back by a reproducing head.

The head gimbal assembly and the hard disk system here have pretty much the same action as the thin-film magnetic head according to the foregoing embodiment.

While the embodiment here has been described with reference to the thin-film magnetic head of the structure wherein the reproducing head portion is located on the substrate side and the perpendicular recording head portion is stacked on the reproducing head, it is contemplated that that order of stacking could be reversed. When the thin-film magnetic head here is used as a read-only head, the recording head could be removed from it.

[Explanation of How to Fabricate the Magnetoresistive Device that is Part of the Invention]

The invention relates to a magnetoresistive device fabrication process, and more specifically to how to fabricate the first ferromagnetic layer 130, non-magnetic intermediate layer 140 and second ferromagnetic layer 150 that are the sensor site of the magnetoresistive device shown in FIG. 1.

In summary, the invention is essentially a process comprising forming the first ferromagnetic layer 130 and the nonmagnetic intermediate layer 140 in order, then applying surface treatment to the surface 141 of the nonmagnetic intermediate layer 140 according to the given method of the invention before the formation of the second ferromagnetic layer 150, and thereafter forming the second ferromagnetic layer 150 on the treated surface 141 of the nonmagnetic intermediate layer 140.

The nonmagnetic intermediate layer 140 is formed of an oxide or nitride. That is, in the invention, the non-magnetic intermediate layer 140 is formed while containing as a main component at least one oxide selected from the group consisting of MgO, Al₂O₃, ZnO, TiO₂, In₂O₃, SnO₂ and ZrO₂ and at least one nitride selected from the group consisting of AlN, TiN, TaN, CuN, ZnN, ZrN and GaN. In other words, the nonmagnetic intermediate layer 140 may be a single layer of one of these components or a multilayer structure of two or more such as Cu/MgO, and Cu/ZnO. The purport of the invention is to hold back influences from oxidization or nitriding from the nonmagnetic intermediate layer 140 at the interface with the second ferromagnetic layer 150 for the purpose of using such oxide or nitride as the nonmagnetic intermediate layer 140.

In the invention, before the formation of the second ferromagnetic layer 150, the surface 141 of the nonmagnetic intermediate layer 140 has previously been treated by a method which lets a modification element hit right on the surface of the nonmagnetic intermediate layer 140 using vacuum in a vacuum atmosphere in a vacuum state. For how to let the modification element hit right on the surface of the nonmagnetic intermediate layer using vacuum, use may be made of vapor deposition, sputtering, ion plating or vapor-phase growth techniques. In these techniques, a metal providing a source for the modification element is used as an evaporation source, a target or the like.

Specifically, modification operation is implemented such that oxygen or nitrogen atoms present on the surface 141 of the nonmagnetic intermediate layer 140 are just enough modified by a low-melting element having a low melting point of 500° C. or lower in an atmosphere in a vacuum state.

The “just enough modified (operation)” here refers to surface treatment in which terminal or adsorbed oxygen or terminal or adsorbed nitrogen present on the surface 141 of the nonmagnetic intermediate layer 140 is modified by the modification element to such an extent that the invention takes effect, resulting in improvements in the MR change rate. To result in improvements in the MR change rate, the diffusion of oxygen or nitrogen through the second ferromagnetic layer 150 must be prevented with no damage to spin conduction. For instance, it is contemplated that a monolayer of the modification element partially piles up on the surface 141 of the nonmagnetic intermediate layer 140. See the examples given later.

For the modification element, use may be made of an element (metal) having a low melting point of 500° C. or lower, preferably 420° C. or lower. Specifically, use is made of one element selected from the group consisting of Zn, Pb, Cd, Ti, Bi, Sn, Se, Li, In, I, S, Na, K, P, Rb, Ga and Cs, among which Zn, Sn or In is most preferable.

When an element having a melting point higher than 500° C. is used as the modification element, there is no remarkable improvement in the magnetoresistive change rate; rather, it would tend to go down.

The invention is now explained in further details with reference to specific experiments.

### Explanation of the Specific Experiments

### EXPERIMENTAL EXAMPLE I

As shown in FIG. 1 and set out in the following Table 1, the underlay layer 121 (4-nm thick NiCr), the antiferromagnetic layer 122 (5-nm thick IrMn), the first ferromagnetic layer 130 (3-nm thick CoFe/0.7-nm thick Ru/3.5-nm thick CoFe), the nonmagnetic intermediate layer 140 (1-nm thick MgO), the second ferromagnetic layer 150 (4-nm thick CoFe) and the cap layer (2-nm thick Ru) were formed in film forms in order.

After the formation of the films, a three-hour heat treatment was carried out at 250° C.

The film assembly was processed into a columnar shape of 100×100 nm, a 20.0-nm thick insulating layer (Al₂O₃) was covered on its sides, and an electrode was formed on its top, thereby preparing the desired MR device samples.

TABLE 1

| | Layer | Thickness |
|---|---|---|
| Multilayer Structure | Material | (nm) |
| Cap Layer (126) | Ru | 2 |

| Magneto- | 2^{nd} | CoFe | 4 |
|---|---|---|---|
| resistive | Ferromagnetic | | |
| Effect | Layer (150) | | |
| Device | Surface Treatment by the Modification | | |
| (500) | Element Zn, Sn, In, Al, and Mg (see | | |
| | Table 2) | | |
| | Nonmagnetic | MgO | 1 |
| | Intermediate | | |
| | Layer (140) | | |
| | 1^{st} | CoFe | 3.5 |
| | Ferromgnetic | Ru | 0.7 |
| | Layer (130) | CoFe | 3 |

| | | |
|---|---|---|
| Antiferromagnetic Layer | IrMn | 5 |
| (122) | | |
| Underlay Layer (121) | NiCr | 4 |

In the process of preparing the aforesaid MR device sample, the nonmagnetic intermediate layer 140 in film form was formed, then surface treatment was applied to the surface 141 of the nonmagnetic intermediate layer 140, and thereafter the second ferromagnetic layer 150 in film form was formed thereon. That is, the surface treatment was applied to the surface 141 of the nonmagnetic intermediate layer 140 by the method wherein the modification element Al, Mg, Zn, Sn, and In was let hit right the surface of the nonmagnetic inter-mediate layer 140 using vacuum in an atmosphere in a vacuum state. Specifically, while the substrate was spaced and fixed 350 nm away from the target (made up of the modification element metal), a 60 W power was applied in an Ar atmosphere of 5.0×10⁻² (Pa) to let each modification element hit right on the substrate for the given treating time on the principles of magnetron sputtering. Note here that MR device samples were prepared for varying treating times of 3, 5, 8, 10, 15, 20, 30, 50, 70, and 100 seconds.

The obtained MR device samples, in units of one hundred, were measured for the MR change rate to find their average, and work out the dispersion of measurements as a standard deviation (σ). Note here that the MR change rates of the MR devices of various constructions were normalized with respect to a reference given by the MR change rate of comparative sample devices with no surface treatment applied to the nonmagnetic intermediate layer 140.

The results are tabulated in Table 2.

TABLE 2

| | Nonmagnetic Intermediate Layer Material: MgO | | | | |
|---|---|---|---|---|---|
| | | | | | Comp. Ex. |
| | Ex. I-1 | Ex. I-2 | Ex. I-3 | Comp. Ex I-1 | I-2 |
| | Surface | Surface | Surface | Surface | Surface |
| Surface | Treating | Treating | Treating | Treating | Treating |
| Treating | Element: | Element: | Element: | Element: | Element: |
| Time t | Zn | Sn | In | Al | Mg |
| (sec) | (m.p. = 420° C.) | (m.p. = 232° C.) | (m.p. = 157° C.) | (m.p. = 660° C.) | (m.p. = 646° C.) |
| 0 | 1.00 | 1.00 | 1.00 | 1.00 | 1.00 |
| 3 | 1.11 | 1.08 | 1.04 | 1.03 | 1.12 |
| 5 | 1.21 | 1.12 | 1.09 | 1.05 | 1.15 |
| 8 | 1.21 | 1.13 | 1.12 | 1.03 | 1.11 |
| 10 | 1.22 | 1.11 | 1.11 | 0.98 | 1.03 |
| 15 | 1.21 | 1.10 | 1.10 | 0.92 | 0.96 |
| 20 | 1.21 | 1.09 | 1.08 | 0.84 | 0.94 |
| 30 | 1.19 | 1.07 | 1.07 | 0.71 | 0.83 |
| 50 | 1.10 | 1.03 | 1.03 | 0.54 | 0.71 |
| 70 | 1.00 | 0.85 | 0.87 | 0.34 | 0.50 |
| 100 | 0.70 | 0.58 | 0.57 | 0.12 | 0.33 |
| MRs | 3% | 2% | 2% | 10% | 8% |

The values at the columns for Examples I-1 to I-3 and Comparative Examples I-1 and I-2 corresponding to the surface treating times, t, in Table 2 are the normalized ones for the MR ratio, and the reference is given by the samples with the surface treating time of 0 second, as noted above.

Referring to the sample group with the surface treating time at which the highest MR change rate was obtained among the MR device samples, the dispersion of the MR change rate was worked out as a standard deviation (σ), as shown at the bottom line (row) in Table 2.

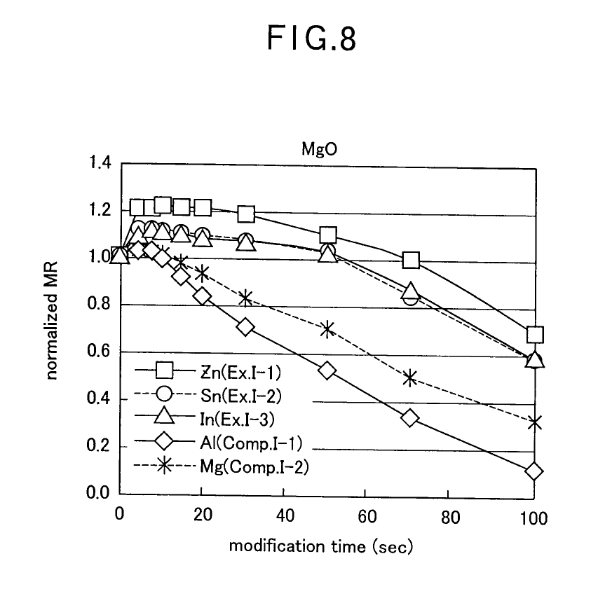

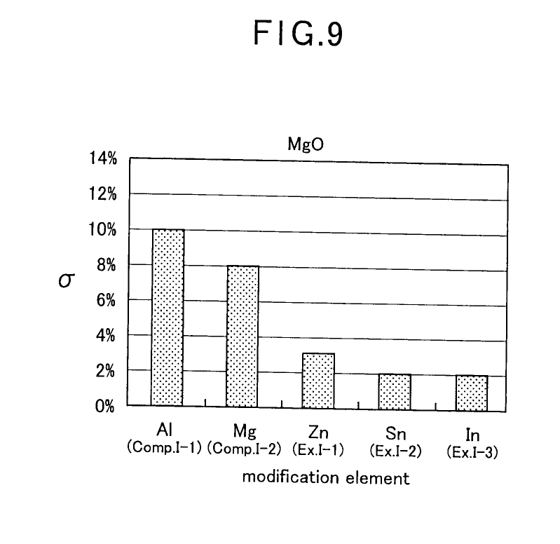

To have a view of what is contained in the data in FIG. 2, a graph indicative of the relations of the surface treating time (modification time) vs. the normalized MR ratio is represented in FIG. 8. Likewise, a graph indicative of the relations of the surface treating element (Zn, Sn, In, Al, Mg) used vs. the standard deviation (σ) of the magnetoresistive change rate is shown in FIG. 9.

### EXPERIMENTAL EXAMPLE II

Following the aforesaid Experimental Example 1, samples were prepared with the exception that the material for the nonmagnetic intermediate layer 140 was changed from MgO to Al₂O₃. See the following Table 3. In otherwise the same way as in Experimental Example 1, the samples were prepared, and experimental data about Experimental Example II were obtained as tabulated in Table 4 given below.

TABLE 3

| | Layer | Thickness |
|---|---|---|
| Multilayer Structure | Material | (nm) |
| Cap Layer (126) | Ru | 2 |

| Magneto- | 2^{nd} | CoFe | 4 |
|---|---|---|---|
| resistive | Ferromagnetic | | |
| Effect | Layer (150) | | |
| Device | Surface Treatment with the | | |
| (500) | Modification Element Zn, Sn, In, Al, | | |
| | Mg (see Table 4) | | |
| | Nonmagnetic | Al₂O₃ | 1 |
| | Intermediate | | |
| | Layer (140) | | |
| | 1^{st} | CoFe | 3.5 |
| | Ferromagnetic | Ru | 0.7 |
| | Layer (130) | CoFe | 3 |

| | | |
|---|---|---|
| Antiferromagnetic | IrMn | 5 |
| Layer(122) | | |
| Underlay Layer(121) | NiCr | 4 |

In the process of preparing the aforesaid MR device sample, the nonmagnetic intermediate layer 140 in film form was formed, then surface treatment was applied to the surface 141 of the nonmagnetic intermediate layer 140, and thereafter the second ferromagnetic layer 150 in film form was formed thereon. That is, the surface treatment was applied to the surface 141 of the nonmagnetic intermediate layer 140 by the method wherein the modification element Al, Mg, Zn, Sn, and In was let hit right the surface of the nonmagnetic inter-mediate layer 140 using vacuum in an atmosphere in a vacuum state. Specifically, while the substrate was spaced and fixed 350 nm away from the target (made up of the modification element metal), a 60 W power was applied in an Ar atmosphere of 5.0×10⁻² (Pa) to let each modification element hit right on the substrate for the given treating time on the principles of magnetron sputtering. Note here that MR device samples were prepared for varying treating times of 3, 5, 8, 10, 15, 20, 30, 50, 70, and 100 seconds.

The obtained MR device samples, in units of one hundred, were measured for the MR change rate to find their average, and work out the dispersion of measurements as a standard deviation (σ). Note here that the MR change rates of the MR devices of various constructions were normalized with respect to a reference given by the MR change rate of comparative sample devices with no surface treatment applied to the nonmagnetic inter-mediate layer 140.

The results are tabulated in Table 4.

TABLE 4

| | Nonmagnetic Intermediate Layer: Al₂O₃ | | | | |
|---|---|---|---|---|---|
| | | | | Comp. Ex. | Comp. Ex. |
| | Ex. II-1 | Ex. II-2 | Ex. II-3 | II-1 | II-2 |
| | Surface | Surface | Surface | Surface | Surface |
| Surface | Treating | Treating | Treating | Treating | Treating |
| Treating | Element: | Element: | Element: | Element: | Element: |
| Time t | Zn | Sn | In | Al | Mg |
| (sec) | (m.p. = 420° C.) | (m.p. = 232° C.) | (m.p. = 157° C.) | (m.p. = 660° C.) | (m.p. = 646° C.) |
| 0 | 1.00 | 1.00 | 1.00 | 1.00 | 1.00 |
| 3 | 1.10 | 1.08 | 1.01 | 1.05 | 1.06 |
| 5 | 1.13 | 1.12 | 1.09 | 1.04 | 1.07 |
| 8 | 1.15 | 1.12 | 1.09 | 1.02 | 1.05 |
| 10 | 1.14 | 1.13 | 1.10 | 0.96 | 0.97 |
| 15 | 1.14 | 1.12 | 1.08 | 0.91 | 0.94 |
| 20 | 1.13 | 1.11 | 1.08 | 0.83 | 0.83 |
| 30 | 1.14 | 1.11 | 1.06 | 0.71 | 0.74 |
| 50 | 1.08 | 1.10 | 1.05 | 0.48 | 0.61 |
| 70 | 1.01 | 1.00 | 0.96 | 0.28 | 0.45 |
| 100 | 0.77 | 0.75 | 0.66 | 0.13 | 0.37 |
| MRs | 3% | 4% | 3% | 12% | 13% |

The values at the columns for Examples II-1 to II-3 and Comparative Examples II-1 and II-2 corresponding to the surface treating times in Table 4 are the normalized ones for the MR ratio, and the reference is given by the samples with the surface treating time of 0 second, as noted above.

Referring to the sample group with the surface treating time at which the highest MR change rate was obtained among the MR device samples, the dispersion of the MR change rate was worked out as a standard deviation (σ), as shown at the bottom line (row) in Table 4.

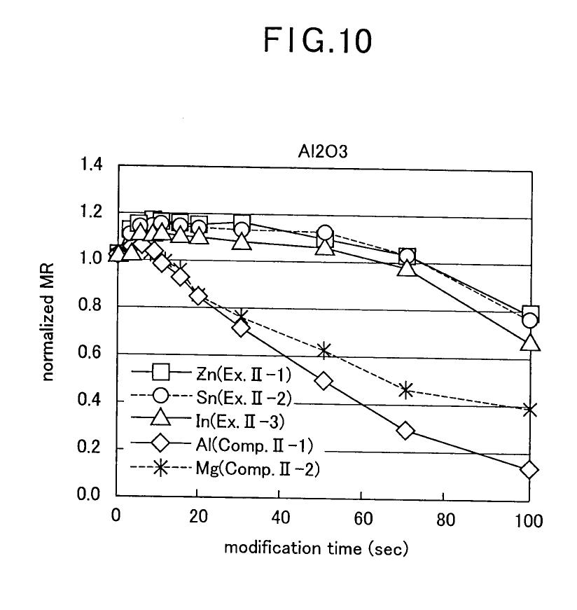

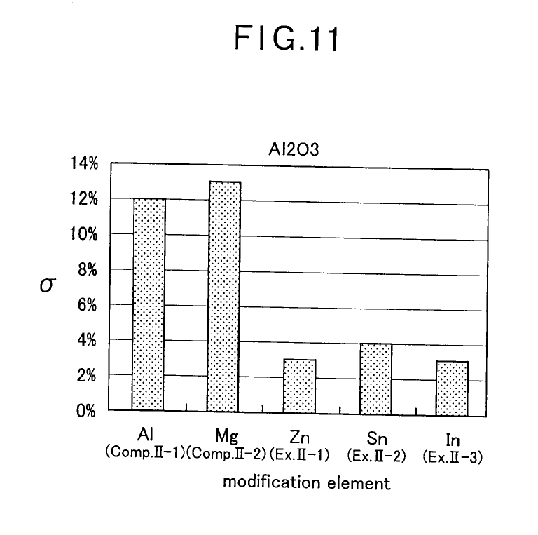

To have a view of what is contained in the data in FIG. 4, a graph indicative of the relations of the surface treating time (modification time) vs. the normalized MR ratio is represented in FIG. 10. Likewise, a graph indicative of the relations of the surface treating element (Zn, Sn, In, Al, Mg) used vs. the standard deviation (σ) of the magnetoresistive change rate is shown in FIG. 11.

### EXPERIMENTAL EXAMPLE III

Following the aforesaid Experimental Example 1, samples were prepared with the exception that the material for the nonmagnetic intermediate layer 140 was changed from MgO to ZnO. See the following Table 5. In otherwise the same way as in Experimental Example 1, the samples were prepared, and experimental data about Experimental Example III were obtained as tabulated in Table 6 given below.

TABLE 5

| | Layer | Thickness |
|---|---|---|
| Multilayer Structure | Material | (nm) |
| Cap Layer (126) | Ru | 2 |

| Magneto- | 2^{nd} | CoFe | 4 |
|---|---|---|---|
| resistive | Ferromagnetic | | |
| Effect | Layer (150) | | |
| Device | Surface Treating by the Modification | | |
| (500) | Element Zn, Sn, In, Al, Mg (see Table | | |
| | 6) | | |
| | Nonmagnetic | ZnO | 1 |
| | Intermediate | | |
| | Layer (140) | | |
| | 1^{st} | CoFe | 3.5 |
| | Ferromagnetic | Ru | 0.7 |
| | Layer (130) | CoFe | 3 |

| | | |
|---|---|---|
| Antiferromagnetic Layer | IrMn | 5 |
| (122) | | |
| Underlay Layer (121) | NiCr | 4 |

In the process of preparing the aforesaid MR device sample, the nonmagnetic intermediate layer 140 in film form was formed, then surface treatment was applied to the surface 141 of the nonmagnetic intermediate layer 140, and thereafter the second ferromagnetic layer 150 in film form was formed thereon. That is, the surface treatment was applied to the surface 141 of the nonmagnetic intermediate layer 140 by the method wherein the modification element Al, Mg, Zn, Sn, and In was let hit right the surface of the nonmagnetic inter-mediate layer 140 using vacuum in an atmosphere in a vacuum state. Specifically, while the substrate was spaced and fixed 350 nm away from the target (made up of the modification element metal), a 60 W power was applied in an Ar atmosphere of 5.0×10⁻² (Pa) to let each modification element hit right on the substrate for the given treating time on the principles of magnetron sputtering. Note here that MR device samples were prepared for varying treating times of 3, 5, 8, 10, 15, 20, 30, 50, 70, and 100 seconds.

The obtained MR device samples, in units of one hundred, were measured for the MR change rate to find their average, and work out the dispersion of measurements as a standard deviation (σ). Note here that the MR change rates of the MR devices of various constructions were normalized with respect to a reference given by the MR change rate of comparative sample devices with no surface treatment applied to the nonmagnetic intermediate layer 140.

The results are tabulated in Table 6.

TABLE 6

| | Nonmagnetic Intermediate Layer: ZnO | | | | |
|---|---|---|---|---|---|
| | | | | Comp. Ex. | Comp. Ex. |
| | Ex. III-1 | Ex. III-2 | Ex. III-3 | III-1 | III-2 |
| | Surface | Surface | Surface | Surface | Surface |
| Surface | Treating | Treating | Treating | Treating | Treating |
| Treating | Element: | Element: | Element: | Element: | Element: |
| Time, t | Zn | Sn | In | Al | Mg |
| (sec) | (m.p. = 420° C.) | (m.p. = 232° C.) | (m.p. = 157° C.) | (m.p. = 660° C.) | (m.p. = 646° C.) |
| 0 | 1.00 | 1.00 | 1.00 | 1.00 | 1.00 |
| 3 | 1.16 | 1.14 | 1.10 | 1.00 | 1.02 |
| 5 | 1.29 | 1.20 | 1.18 | 1.02 | 1.01 |
| 8 | 1.28 | 1.21 | 1.18 | 1.98 | 0.96 |
| 10 | 1.28 | 1.19 | 1.17 | 0.94 | 0.94 |
| 15 | 1.26 | 1.18 | 1.17 | 0.90 | 0.91 |
| 20 | 1.26 | 1.16 | 1.16 | 0.81 | 0.86 |
| 30 | 1.26 | 1.16 | 1.15 | 0.69 | 0.79 |
| 50 | 1.23 | 1.14 | 1.13 | 0.52 | 0.63 |
| 70 | 1.11 | 1.01 | 0.95 | 0.30 | 0.41 |
| 100 | 0.88 | 0.72 | 0.62 | 0.10 | 0.12 |
| MRs | 4% | 4% | 4% | 13% | 13% |

The values at the columns for Examples III-1 to III-3 and Comparative Examples III-1 and III-2 corresponding to the surface treating times in Table 6 are the normalized ones for the MR ratio, and the reference is given by the samples with the surface treating time of 0 second, as noted above.

Referring to the sample group with the surface treating time at which the highest MR change rate was obtained among the MR device samples, the dispersion of the MR change rate was worked out as a standard deviation (σ), as shown at the bottom line (row) in Table 6.

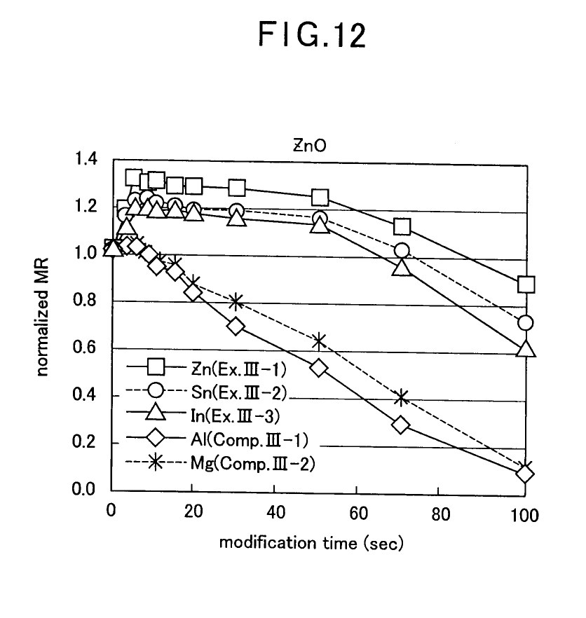

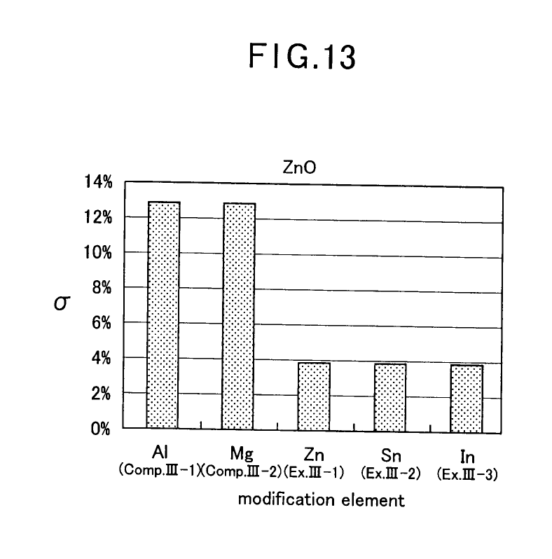

To have a view of what is contained in the data in FIG. 4, a graph indicative of the relations of the surface treating time (modification time) vs. the normalized MR ratio is represented in FIG. 12. Likewise, a graph indicative of the relations of the surface treating element (Zn, Sn, In, Al, Mg) used vs. the standard deviation (σ) of the magnetoresistive change rate is shown in FIG. 13.

From the results of experimentation as described above, the following technical conclusions would be derived.

With all the modification materials (Zn, Sn, In, Al, Mg) used in the experimentation, the increase in the MR change rate is more or less found by the surface treatment of the surface 141 of the nonmagnetic intermediate layer 140.

With the elements having a high melting point greater than 500° C. such as Al and Mg used in the comparative examples, however, the element modification time (surface treating time, t) taking part in the increase in the MR change rate is significantly shorter than that with the low melting element like Zn, Sn, and In having a melting point of 500° C. or lower. And, Al and Mg used as comparisons are found to give rise to some deterioration of the MR change rate as the modification time grows longer. This fact would imply that although the high-melting elements having a melting point higher than 500° C., like Al and Mg, act to prevent the ferromagnetic material from bonding to oxygen, they are susceptible of lamination with an excessively laminated site doing damage to spin conduction, resulting in a lowering of MR. It is also found that there is a large standard deviation (σ) leading to some considerable dispersion of the MR change rate. This means that with the high-melting element it is very difficult to derive just enough, or the optimum, modification conditions.

With the low-melting elements having a melting point of 500° C. or lower such as Zn, Sn and In used herein, on the other hand, there would be a phenomenon in which, while the surface 141 of the nonmagnetic intermediate layer 104 is being treated, atoms taking no part in the modification of oxygen terminals come off that surface easily or they are less likely to be laminated as a film. In short, the surface 141 of the nonmagnetic intermediate layer 140 can be just enough modified. It is also appreciated that there is a reduced standard deviation (σ) value, and a limited dispersion of the MR change rate as well. This means that the conditions for just enough modification could be very easily derived.

It is also found that even with the low-melting elements having a low melting point of 500° C. or lower such as Zn, Sn and In, the film starts to be laminated from the time at which the element modifying time (surface treating time, t) is past about 50 seconds, holding back spin conduction. Such a state would be taken as an over-modification state.

From the foregoing results of experimentation, the advantages of the invention would be undisputed. That is, the invention provides a process for the formation of a sensor site of a magnetoresistive device in which the first ferromagnetic layer and the nonmagnetic intermediate layer are formed in order, then surface treatment is applied to the surface of said nonmagnetic intermediate layer, and thereafter the second ferromagnetic layer is formed on the thus treated surface of said nonmagnetic intermediate layer, wherein said surface treatment is implemented by a method of letting a modification element hit right on the surface of said nonmagnetic intermediate layer using a vacuum, said nonmagnetic intermediate layer is composed mainly of an oxide or nitride, and said modification element is composed of a low-melting element having a melting point of 500° C. or lower. It is thus possible to reduce spin scattering while reducing oxidization or nitriding of the surfaces of the ferromagnetic layers used for said sensor site, thereby achieving high MR change rates. There is also a limited dispersion of the MR change rate with extremely improved reliability.

### INDUSTRIAL APPLICABILITY

The present invention could be applied to the industry of magnetic disk systems comprising a magneto-resistive device operable to read the magnetic field intensity of magnetic recording media or the like as signals.

What we claim is:

1. A fabrication process for a magnetoresistive device of CPP (current perpendicular to plane) structure, which comprises a nonmagnetic intermediate layer, and a first ferromagnetic layer and a second ferromagnetic layer stacked and formed with said nonmagnetic intermediate layer sandwiched between them, and in which an angle made between directions of magnetization of both said ferromagnetic layers is capable of functioning in such a way as to change relatively depending on an external magnetic field, with a sense current applied in a stacking direction, characterized in that:
said first ferromagnetic layer and said nonmagnetic intermediate layer are formed in order, then surface treatment is applied to a surface of said nonmagnetic intermediate layer, and thereafter said second ferromagnetic layer is formed on the thus treated surface of said nonmagnetic intermediate layer,
said surface treatment is implemented by a method of letting a modification element hit right on the surface of said nonmagnetic intermediate layer using a vacuum,
said nonmagnetic intermediate layer is composed mainly of an oxide or nitride, and
said modification element is a low-melting element having a melting point of 500° C. or lower.

2. The fabrication process according to claim 1, wherein said surface treatment is operated such that the surface of said nonmagnetic intermediate layer is just enough modified by the low-melting element having a melting point of 500° C. or lower.

3. The fabrication process according to claim 2, wherein the operation for just enough modification by the low-melting element having a melting point of 500° C. or lower is implemented in a range where there is an improvement in MR change rates.

4. The fabrication process according to claim 2, wherein the operation for just enough modification by the low-melting element having a melting point of 500° C. or lower is implemented in a range where diffusion of oxygen through said second ferromagnetic layer is prevented and there is no damage to spin conduction.

5. The fabrication process according to claim 1, wherein said method of letting a modification element hit right on the surface of the nonmagnetic intermediate layer using a vacuum is a vapor deposition, ion plating or vapor-phase growth technique.

6. The fabrication process according to claim 1, wherein said nonmagnetic intermediate layer is composed mainly of at least one oxide selected from the group consisting of MgO, Al₂O₃, ZnO, TiO₂, In₂O₃, SnO₂ and ZrO₂.

7. The fabrication process according to claim 1, wherein said nonmagnetic intermediate layer is composed mainly of at least one nitride selected from the group consisting of AlN, TiN, TaN, CuN, ZnN, ZrN and GaN.

8. The fabrication process according to claim 1, wherein said nonmagnetic intermediate layer is a Cu/MgO multilayer or Cu/ZnO multilayer.

9. The fabrication process according to claim 1, wherein said low-melting element having a melting point of 500° C. or lower is Zn, Pb, Cd, Ti, Bi, Sn, Se, Li, In, I, S, Na, K, P, Rb, Ga, or Cs.

10. The fabrication process according to claim 1, wherein said low-melting element having a melting point of 500° C. or lower is Zn, Sn, or In.

11. The fabrication process according to claim 1, wherein said nonmagnetic intermediate layer is composed mainly of at least one oxide selected from the group consisting of MgO, Al₂O₃, and ZnO.

12. A process for fabricating a thin-film magnetic head, comprising:
a plane in opposition to a recording medium,
a magnetoresistive device located near said medium opposite plane to detect a signal magnetic field from said recording medium, and
a pair of electrodes from passing a current in a stacking direction of said magneto resistive device, characterized in that said magneto resistive device is fabricated by the fabrication process according to claim 1.

13. A process for fabricating a head gimbal assembly, comprising:
a slider including a thin-film magnetic head and located in such a way as to oppose to a recording medium, and
a suspension adapted to resiliently support said slider, characterized in that said thin-film magnetic head is fabricated by the fabrication process according to claim 12.

14. A process for fabricating a magnetic disk system, characterized by comprising:
a slider including a thin-film magnetic head and located in such a way as to oppose to a recording medium, and
a positioning device adapted to support and position said slider with respect to said recording medium, characterized in that said thin-film magnetic head is fabricated by the fabrication process according to claim 12.
